(19) United States
(12) Patent Application Publication
(10) Pub. No.: US 2006/0090356 A1
(43) Pub. Date: May 4, 2006

(54) Vehicle wheel alignment angle sensor system incorporating two-dimensional imaging sensor array

(75) Inventor: Micheal T. Stieff, Wentzville, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Hunter Engineering Company

(21) Appl. No.: 11/259,977

(22) Filed: Oct. 27, 2005

Related U.S. Application Data
(60) Provisional application No. 60/623,574, filed on Oct. 29, 2004.

(51) Int. Cl. G01B 5/255

(52) U.S. Cl. 33/288

(57) ABSTRACT

A vehicle wheel alignment system with a wheel alignment angle sensor adapted for removable attachment to a vehicle wheel assembly, incorporating a two-dimensional imaging array at an orientation relative to a sensor mounting axis. The two-dimensional imaging array is configured to form an image of light from one or more remote light sources. The horizontal and vertical position of the images on the two-dimensional imaging array are representative of at least two angular orientations of the wheel alignment angle sensor relative to the remote light source, which is preferably coupled to an adjacent vehicle wheel assembly.

### CROSS-REFERENCE TO RELATED APPLICATIONS

The present application is related to, and claims priority from U.S. Provisional Application No. 60/623,574, filed Oct. 29, 2004, which is incorporated by reference.

### STATEMENT REGARDING FEDERALLY SPONSORED RESEARCH

Not Applicable.

### BACKGROUND OF THE INVENTION

The present invention is related to vehicle wheel alignment systems, an in particular to sensors in a vehicle wheel alignment system which include a two-dimensional active pixel array light detector for imaging a remotely disposed light source to determine an angular orientation of a vehicle wheel.

Traditionally, linear imaging devices have been used in various wheel angular orientation transducer configurations to measure wheel alignment angles. A first vehicle wheel alignment angle sensor unit 10, such as shown in FIG. 1, is removably disposed on a first vehicle wheel assembly 12. The wheel alignment angle sensor unit includes an imaging means for detecting light emitted along a line-of-sight from a remote light source, typically disposed on a second wheel alignment angle sensor unit on an adjacent vehicle wheel, as shown in FIG. 2. A cylindrical lens, an aperture, or other means for focusing incoming light is placed over a linear or one-dimensional imager array, such as linear charge-coupled device (CCD) as used in DSP300/500 sensors from Hunter Engineering Company of Bridgeton, Mo. The linear imager forms an image of a light source that is located remotely from the transducer which is measuring a particular angle. The position at which the image falls on the linear imager is related to the angle being measured.

U.S. Pat. No. 5,018,853 to Hechel et al., assigned to Hunter Engineering Co., describes an example of such a device. Similarly, U.S. Pat. No. 6,313,911 B1 to Stieff and U.S. Pat. No. 6,483,577 B2 to Stieff, also assigned to Hunter Engineering Co., describe an application where two of these types of devices are positioned in a vehicle wheel alignment angle sensor unit with their linear imager arrays arranged such that the axes along which the active elements (pixels) of each individual imagers are aligned are normal to each other. In this arrangement, the imager whose pixels are arranged along one axis responds to a change in a first alignment angle, whereas the second imager array is responsive to a change of a second alignment angle.

Vehicle wheel alignment systems from Launch Tech Co. Ltd., of Futian, P. R. China, such as the KWA-501 Wireless Wheel Aligner, utilize two-dimensional CMOS imaging sensors in a vehicle wheel alignment angle sensor unit for measurement of vehicle wheel toe alignment angles only. The KWA-501 alignment system acquires measurements of other vehicle wheel alignment angles such as camber and caster adjust, from digital inclinometers.

Accordingly, it would be advantageous to provide a vehicle wheel alignment system which is capable of acquiring measurements of two or more vehicle wheel alignment angles, such as toe and camber, or toe and caster adjust, utilizing a single two-dimensional imaging sensor

### BRIEF SUMMARY OF THE INVENTION

Briefly stated, the present invention provides a vehicle wheel alignment system with a wheel alignment angle sensor adapted for removable attachment to a vehicle wheel assembly, incorporating a two-dimensional imaging array at an orientation relative to a mounting axis. The two-dimensional imaging array is configured to form an image of focused light from a remote light source. The horizontal and vertical position of the image on the two-dimensional imaging array is representative of the angular orientation of the wheel alignment angle sensor relative to the remote light source in two dimensions when coupled to an adjacent vehicle wheel assembly.

In an alternate embodiment, the present invention provides a vehicle wheel alignment system with a wheel alignment angle sensor adapted for removable attachment to a vehicle wheel assembly, incorporating a two-dimensional imaging array. The two-dimensional imaging array is configured to form an image of focused light from a remote light source. The horizontal and vertical position and orientation of the image on the two-dimensional imaging array is representative of the angular orientation of the wheel alignment angle sensor relative to the remote light source in two dimensions, when coupled to an adjacent vehicle wheel assembly.

In a next alternate embodiment, the present invention provides a vehicle wheel alignment system with a wheel alignment angle sensor adapted for removable attachment to a vehicle wheel assembly, incorporating a two-dimensional imaging array at an orientation relative to a mounting axis. The two-dimensional imaging array is configured to form a two-dimensional image of focused light from a remote light source. The horizontal and vertical position, together with the orientation, of the two-dimensional image on the two-dimensional imaging array is representative of a plurality of angular orientations of the wheel alignment angle sensor relative to the remote light source when coupled to an adjacent vehicle wheel assembly.

In a next alternate embodiment, the present invention provides a vehicle wheel alignment system with a wheel alignment angle sensor adapted for removable attachment to a vehicle wheel assembly, incorporating a two-dimensional imaging array disposed at an orientation relative to a mounting axis. The two-dimensional imaging array is configured to form multiple images of focused light from a set of remote light sources. The position, relationships between, and optionally the orientation, of the images on the two-dimensional imaging array is representative of distance to, and at least two angular orientations of the wheel alignment angle sensor relative to the remote light sources when coupled to an adjacent vehicle wheel assembly.

In a next alternate embodiment, the present invention provides a vehicle wheel alignment system with a wheel alignment angle sensor adapted for removable attachment to a vehicle wheel assembly, incorporating a two-dimensional imaging array. The imaging array is aligned such that rows of imaging elements are disposed in a substantially horizontal orientation and columns of imaging elements are disposed in substantially vertical orientation when the sensor is attached to a vehicle wheel assembly. The two-dimensional imaging array is configured to form an image of light from a remote light source. The position and orientation of the image on the two-dimensional imaging array is representative of an angular orientation of the wheel alignment angle sensor in two dimensions relative to the remote light source when coupled to an adjacent vehicle wheel assembly.

In an alternate embodiment, the present invention provides a vehicle wheel alignment system with a wheel alignment angle sensor adapted for removable attachment to a vehicle wheel assembly, incorporating a two-dimensional imaging array. The two-dimensional imaging array is configured to form images of light from at least one remote light source. The position, orientation, and/or relationship of the images on the two-dimensional imaging array is representative of an angular orientation of the wheel alignment angle sensor in at least two dimensions relative to the remote light sources, from which a vehicle wheel alignment angle including a toe angle and either a camber angle or caster adjust angle is determinable.

In an alternate embodiment, the present invention provides a vehicle wheel alignment system with a wheel alignment angle sensor adapted for removable attachment to a vehicle wheel assembly, incorporating a two-dimensional imaging array. The two-dimensional imaging array is configured to form images of light from two or more remote light sources disposed in relationship to separable vehicle components. The position, orientation, and/or relationship of the images on the two-dimensional imaging array is representative of an angular orientation of the wheel alignment angle sensor in at least two dimensions relative to the remote light sources, from which at least two angular relationships between the separable vehicle components is determinable.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of a prior art vehicle wheel alignment angle sensor unit disposed on a vehicle wheel assembly;

FIG. 2 is a side view of a pair of prior art vehicle wheel alignment angle sensor units disposed on adjacent vehicle wheel assemblies;

FIG. 3 is a simplified representation of the orientations and relationships between a remote light source and an imaging element having a two-dimensional pixel array mounted to a vehicle wheel assembly;

FIG. 4 is a representation of a linear image projected onto an imaging element having a two-dimensional pixel array;

FIG. 5 is a representation of a linear image projected in a skewed manner onto an imaging element having a two-dimensional pixel array;

FIG. 6 is representative of a circular image projected onto an imaging element having a two-dimensional pixel array; and

FIG. 7 is a simplified representation of an alternate embodiment orientation and relationship between a remote light source and an imaging element having a two-dimensional pixel array mounted to a vehicle wheel assembly.

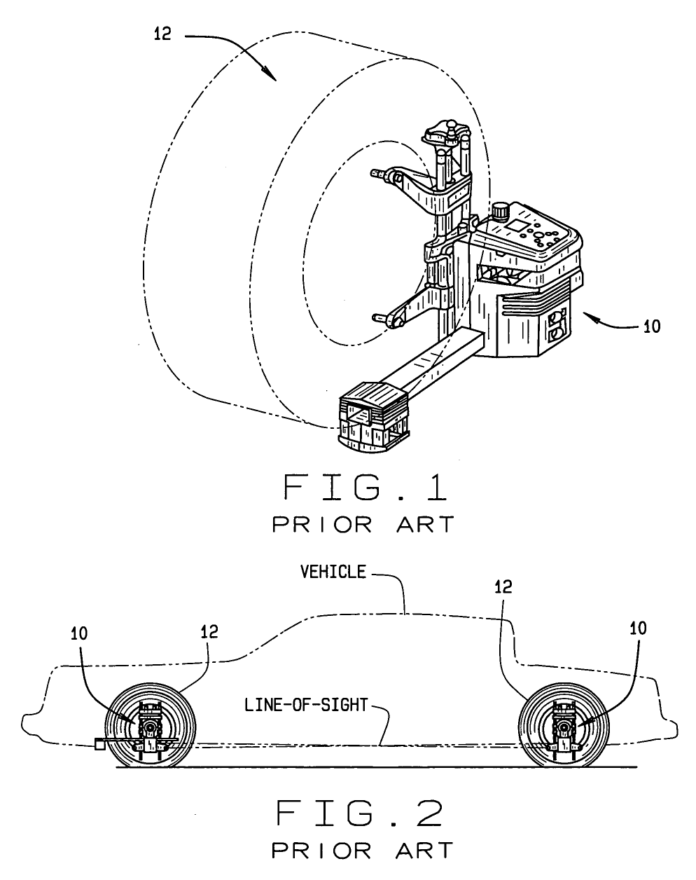

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The current invention provides an improvement to a vehicle wheel alignment system having at least one vehicle wheel alignment angle sensor unit 10. The improvement incorporates a single two-dimensional imaging array 100, configured to measure at least two wheel alignment angles, into the vehicle wheel alignment angle sensor unit 10. The two-dimensional imaging array 100 is preferably a CMOS image sensor array, but those of ordinary skill in the art will recognize that other types of image sensor arrays may be utilized. As is conventional, the wheel alignment angle sensor unit 10 contains a processor or logic circuit (not shown) and is configured for removable attachment to a vehicle wheel assembly 12 about an axis A which is substantially normal to the plane P of the wheel assembly in a conventional manner, such as with the aid of a conventional wheel adapter or wheel clamp assembly.

The vehicle wheel alignment angle sensor unit 10 is provided with a conventional means for communicating with a vehicle wheel alignment system control unit and/or additional vehicle wheel alignment angle sensor units (not shown). Suitable communications means may include, for example, a radio frequency transceiver, an infrared or optical transceiver, or a serial communication cable.

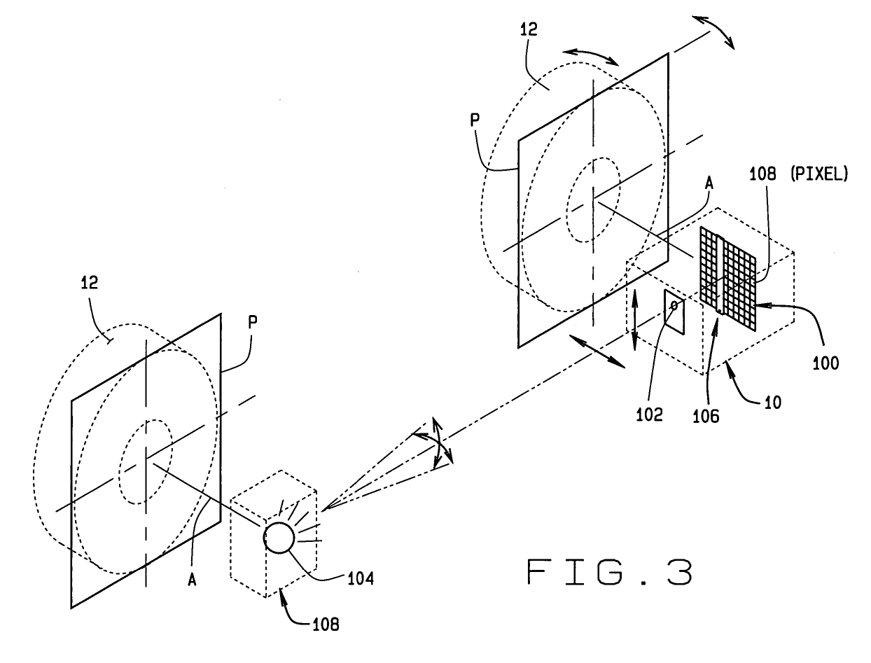

To measure at least two wheel alignment angles, a means for producing an image of a light source, such as an aperture or lens 102, is positioned between a remote light source 104 and the imager array 100 of the vehicle wheel alignment angle sensor 10. Preferably, the remote light source 104 is removably mounted to a transverse or laterally adjacent vehicle wheel assembly and may be disposed within a second vehicle wheel alignment angle sensor unit 10B, and the imager array 100 is disposed normal to the wheel plane P of the wheel assembly 12 onto which the receiving vehicle wheel alignment angle sensor 10 is mounted, as is shown in FIG. 3. As an angular relationship between the remote light source 104 and the vehicle wheel alignment angle sensor unit 10 changes, such as during a vehicle wheel alignment angle adjustment, an image 106 of the remote light source 104 produced on the imager array 100 moves over the surface of the imager array 100 in response to that change. This image 106 may move along either a row or a column of pixel elements 108 of the imager array 100, such that the change in position of the image 106 along the row and/or column of pixel elements 108 is indicative of angular changes in two dimensions.

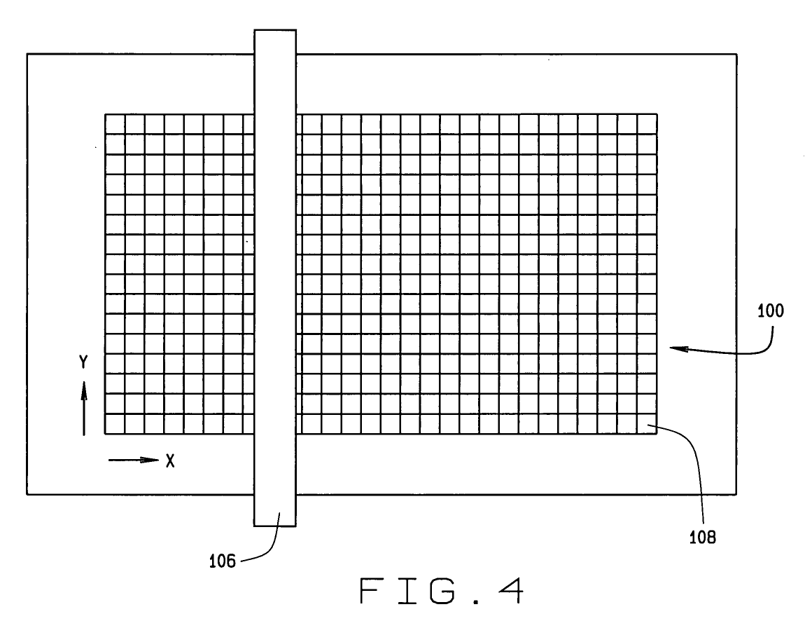

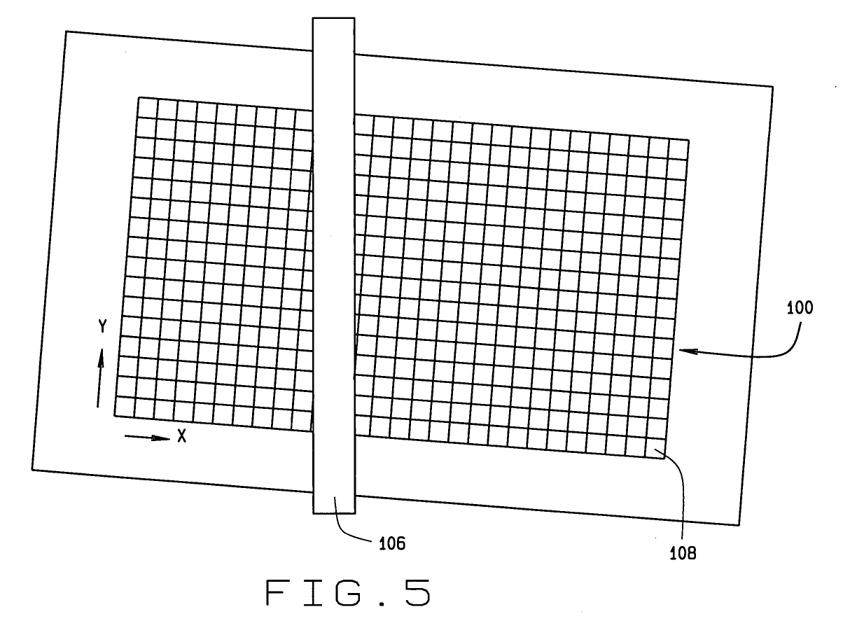

In one embodiment, the image 106 formed by the aperture or cylindrical lens is sufficiently linearly elongated such that more than one row or column of pixel elements 108 in the imager array 100 is illuminated by the image, such as shown in FIG. 4. In this case, examination of all of (or any portion thereof the illuminated rows or columns of pixel elements 108 is used to determine the angular changes, providing a more accurate measurement.

If the angular relationship between the remote light source 104 and the vehicle wheel alignment sensor unit 10 is rotated about an axis “X” which is perpendicular to the imaging array 100, the elongated image may not be aligned with either the columns or rows of pixel elements 108 of the imager array 100, and be skewed as shown in FIG. 5. In this case the position of the illuminated pixel elements 108 in both columns and rows (x and y) of the imager array 100 is used to determine the position of the image 106 on the imager array 100. This provides a means of further increasing accuracy by allowing more information to be accumulated and used in determining the exact position of the image 106 relative to the imager array 100.

Since the edges of the image 106 on the imager array 100 do not align with a single row or column of pixel elements 108, a higher effective resolution can be obtained using image processing algorithms to mathematically interpolate the location of the edges of the image 106 on the imager array 100 to a sub-pixel resolution.

Preferably, signals representative of digital image data from the imager array 100 are directly processed by the processor or logic circuit of the wheel alignment angle sensor unit 10 to calculate a relative angular orientation of the imager array 100 based on the position and/or orientation of the image 106. The results of the calculations are communicated to a vehicle wheel alignment system control unit (not shown), preferably in the form of vehicle wheel alignment angle information, using any conventional data communication system. In alternative embodiments, the processor or logic circuit carrying out the calculations is remote from the vehicle wheel alignment sensor unit 10, and receives the output from the imager array 100 via a wireless or corded communication link.

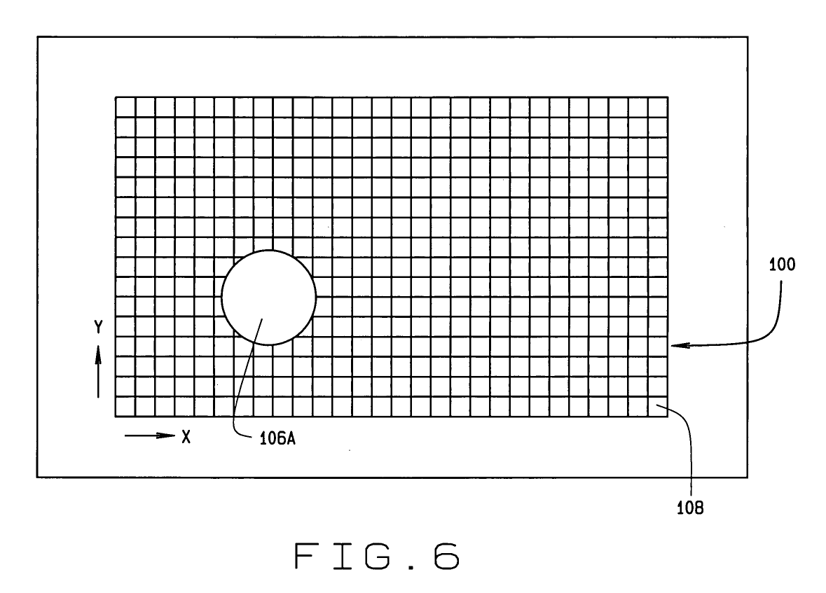

In an alternate embodiment of the current invention a non-linear image of the remote light source, such as the circular image 106A shown in FIG. 6, is formed on the imager array 100. Any image 106A that is of any non-linear shape surrounded by non-illuminated pixels 108 on the imager array 100 will function the same as a linear image 106 for purposes of identifying a two-dimensional positional relationship between the imager array 100 and the remove light source 104. The position of the non-linear image 106A is determined relative to the imager array 100 and corresponds to the angle being measured. The position may vary in direction along either a row or column of pixel elements 108, or a combination thereof, depending on the angular relationships between the imaging array 100, the imaging means 102, and the remote light source 104.

In one embodiment the imager array 100 is positioned with the pixel rows oriented essentially parallel to the axis A of a mounting shaft that supports the vehicle wheel alignment angle sensor unit 10 on the wheel adaptor removably coupled to the vehicle wheel assembly 12, such as shown in FIG. 3. With the imaging array 100 disposed in this position, more than one wheel alignment angle can be measured. For example, varying the toe angle of the wheel assembly 12 to which the imaging array 100 is mounted, i.e. movement about an arc in a horizontal plane of the supporting axis A, results in the image 106 of the remote light source 104 to move parallel to the rows of the imager array 100, i.e. horizontally. Hence, a change in the horizontal position of the image 106 on the imaging array 100 is representative of the change in the wheel toe angle.

If the vehicle wheel alignment angle sensor is rotated about the mounting or support axis A, an image 106 of the remote light source 104 on the imaging array 100 will move vertically across the imaging array 100, parallel to the pixel columns. This vertical movement is related to the amount of rotation of the sensor unit 10, and may optionally be used as an assessment of the level condition of the sensor unit 10, or as a measurement of an adjustment to the vehicle wheel caster adjust angle. Essentially this measuring capability may replace (or verify) the function that has been conventionally provided by a caster-adjust inclinometer.

If the vehicle wheel alignment angle sensor is moved about an arc within the vertical plane of the supporting axis A, i.e. an alteration of the wheel assembly camber angle, an image 106 of the remote light source 104 on the imaging array 100 will move bother horizontally and vertically across the imaging array 100. Essentially this measuring capability may replace (or verify) the function that has been conventionally provided by a camber inclinometer.

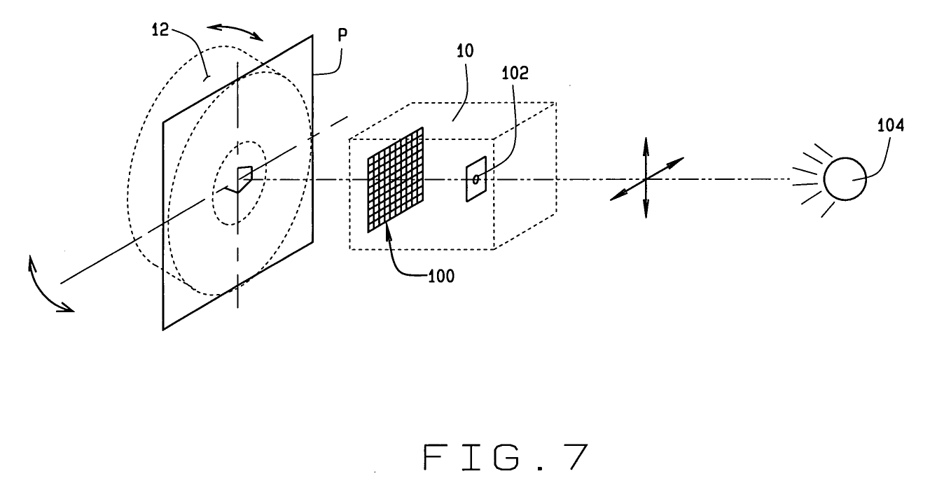

In an alternate embodiment, the imager array 100 is disposed normal to the vehicle wheel alignment sensor unit support shaft axis A, with the pixel rows oriented essentially horizontal and the pixel columns therefore essentially vertical, as shown in FIG. 7. In this position, more than one alignment angle can again be measured by observing an image 106 of a remote light source 104 projected onto the imaging array 100. Varying the toe angle of the wheel assembly 12 to which the imager array 100 is mounted will cause the image 106 of the remote light source 104 to move horizontally across the imager array 100, i.e., parallel to the pixel rows of the imager array 100. This movement is essentially proportional to the change in the toe angle.

Similarly, varying the camber of the wheel assembly 12 will cause the image 106 of the remote light source 104 projected onto the imaging array 100 to move vertically along the pixel columns of the imaging array 100, replacing (or verifying) measurements which have been conventionally performed with a camber inclinometer or gravity referenced accelerometer.

In an alternate embodiment, images 106 from multiple remote light sources 104 which are disposed in a known configuration are formed simultaneously on the imaging array 100 by the imaging means 102. The separation of the images 106 of the individual remote light sources 104 on the imager array 100 can be related to the known configuration of the light sources 104 through well know mathematical techniques, and the distance between the imaging array 100 and remote light sources 104 determined there from.

Similarly, the positions on the imaging array 100 of the individual images 106 from each of the multiple light sources 104 can also be used to determine a relative measurement of a wheel alignment angle, such as camber, in a manner similar to that described in U.S. Pat. No. 6,313,911 B1 to Stieff and U.S. Pat. No. 6,483,577 B2 to Stieff, each of which is herein incorporated by reference. If the individual remote light sources 104 are disposed essentially above and below each other in a common vertical plane, then the images 106 of each of the remote light sources 104 formed on the imaging array 100 will essentially fall along a common pixel column of the imager array 100 when the relative camber of the wheel alignment angle sensor to which the imaging array 100 is attached, and the sensor unit 10 to which the remote light sources 104 are attached, is substantially zero degrees.

In a similar fashion, if the individual remote light sources 104 are essentially positioned in a common horizontal plane relative to each other, then the images 106 of the remote light sources 104 on the imaging array 100 will fall along a common pixel row of the imager array 100, when the relative camber of the wheel alignment angle sensor to which the imaging array 100 is attached, and the sensor unit 10 to which the remote light sources 104 are attached, is substantially zero degrees. As the relative camber angle changes between the sensors units 10, the position of the images 106 on the imaging array 100 will shift along the rows of the imager array 100 in the case of vertical disposition of the remote light sources 104, or essentially along the columns of the imager array 100 in the case of horizontal disposition of the remote light sources 104. This relative movement of the images 106 across the surface of the imager array 100 can be related to the relative change in a camber wheel alignment angle.

The above method of determining relative camber requires the use of at least two remote light sources 104 but obviously could accommodate additional remote light sources 104. The remote light sources 104 are not restricted to be aligned in a linear fashion. While the previously described methods assume that the imager array 100 is oriented such that the pixel columns are essentially oriented in a vertical direction and therefore the pixel rows are essentially horizontal, it will be obvious to those of ordinary skill in the art that this may not always be the case. In a more general condition both the imager array 100 and imaging means 102, together with the remote light sources 104 may be oriented at unknown angles relative to horizontal/vertical and/or each other. In this case, the wheel alignment angle sensors units 10 for which the relative camber is being measured must be initially placed in a position where the relative camber orientation between them is known. The initial position of the images 106 along both the rows and columns of the imaging array 100 is noted. With this information known, as the relative camber of the sensors unit changes, the relative positions of the images 106 on the imaging array 100 will also change. This relative change of image position can be related to the relative change in camber.

Another application of a two-dimensional imager array 100 for measuring wheel alignment parameters is to measure the ride height and/or wheel offset position relative to the body of the vehicle. In this application a remote light source 104 (or a plurality of remote light sources 104) is mounted to the fender adjacent a wheel assembly 12 of the vehicle in a known or determinable relationship to the wheel assembly 12. A second remote light source 104 (or a second plurality of remote light sources 104) are mounted to the vehicle wheel assembly 12 in a known or determinable relationship. A sensor unit 10 including a two-dimensional imager array 100 and imaging means 102 is disposed to view both the light sources 104 on the vehicle wheel and the light sources 104 on the fender, and preferably is mounted to an adjacent vehicle wheel assembly 12 on the same side of the vehicle. The position on the imager array 100 of the image(s) 106 of the light source(s) 104 mounted to the fender is compared to the position of the image(s) 106 of the light source(s) 104 mounted to the wheel assembly 12, and the relative position of the wheel assembly 12 to the fender is then determined from the known or predetermined relationships of the various light sources 104. Those of ordinary skill will recognize that this embodiment of the present invention is not limited to locating a vehicle fender relative to a vehicle wheel assembly 12, but that any portion of a vehicle body may be located relative to a wheel assembly 12 or other feature by the attachment of suitable light sources 104 thereto, which can be imaged by the two-dimensional imaging array 100.

The present invention can be embodied in part in the form of computer-implemented processes and apparatuses for practicing those processes. The present invention can also be embodied in part in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved vehicle wheel alignment angle sensor unit having a sensor housing adapted for removable attachment to a vehicle wheel assembly about a mounting axis, and a sensor logic circuit configured to communicate with a vehicle wheel alignment system, the improvement comprising:
an imaging array having at least two parallel rows of pixel elements, said imaging array operatively coupled to the sensor logic circuit; and
an imaging means disposed in relationship to the imaging array, said imaging means configured to direct light from a first remote light source to form a first image on said imaging array; and
wherein a location on said imaging array of said first image is related to an angular orientation of the imaging array in two dimensions, said two dimensions representative of two vehicle wheel alignment angles.

2. The improved vehicle wheel alignment angle sensor unit of claim 1 wherein said imaging array is a CMOS sensor.

3. The improved vehicle wheel alignment angle sensor unit of claim 1 wherein the sensor logic circuit is further configured to receive signals from said imaging array representative of a location of said first image on said imaging array, said location representative of an angular relationship between said imaging array and said first remote light source.

4. The improved vehicle wheel alignment angle sensor unit of claim 1 wherein said imaging array is disposed normal the mounting axis.

5. The improved vehicle wheel alignment angle sensor unit of claim 1 wherein said imaging array is disposed parallel to the mounting axis.

6. The improved vehicle wheel alignment angle sensor unit of claim 1 wherein said imaging means is configured to direct said light from said first remote light source linearly onto said imaging array.

7. The improved vehicle wheel alignment angle sensor unit of claim 6 wherein said imaging means is a cylindrical lens.

8. The improved vehicle wheel alignment angle sensor unit of claim 6 wherein said imaging means is an aperture.

9. The improved vehicle wheel alignment angle sensor unit of claim 1 wherein said two vehicle wheel alignment angles are selected from a set of wheel alignment angles including toe, camber, and caster adjust.

10. The improved vehicle wheel alignment angle sensor unit of claim 1 wherein said imaging means is further configured to direct light from a second remote light source to form a second image on said imaging array; and
wherein a location on said imaging array of said second image, relative to said first image, is proportional to a distance between said imaging array and said first and second remote light sources.

11. In a vehicle wheel alignment system, a cooperative pair of vehicle wheel alignment sensors comprising:
a first sensor for attachment to a first vehicle wheel assembly, said first sensor including an imaging array having at least two parallel rows of pixel elements, said imaging array operatively coupled to a sensor logic circuit;
a second sensor for attachment to a second vehicle wheel assembly adjacent to said first vehicle wheel assembly, said second sensor including at least a first light source visible to said imaging array; and
wherein said sensor logic circuit is configured to measure at least two angles associated with said first vehicle wheel assembly by observing at least a position of an image of said first light source on said imaging array.

12. The vehicle wheel alignment system of claim 11 wherein said sensor logic circuit is configured to measure a first angle associated with said first vehicle wheel by observing a position of said image along a first axis of said imaging array, and to measure a second angle associated with said first vehicle wheel assembly by observing a position of said focused image along a second axis of said imaging array.

13. The vehicle wheel alignment system of claim 11 wherein said sensor logic circuit is configured to measure an angle associated with said first vehicle wheel assembly by determining a position of said image of said first light source on said imaging array to a sub-pixel resolution.

14. The vehicle wheel alignment system of claim 11 wherein said sensor logic circuit is configured to measure at least two angles associated with said first vehicle wheel assembly by determining a position and an orientation of said image of said first light source on said imaging array.

15. The vehicle wheel alignment system of claim 14 wherein said two angles are selected from a set of wheel alignment angles including toe, camber, and caster adjust.

16. The vehicle wheel alignment system of claim 11 wherein said second sensor further includes a second light source visible to said imaging array; and
wherein said sensor logic circuit is configured to measure a distance between said first and second sensors by observing a position of an image of said second light source on said imaging array relative to said position of said image of said first light source.

17. An improved vehicle wheel alignment system including a vehicle wheel alignment angle sensor unit having a sensor housing adapted for removable attachment to a vehicle wheel assembly about a mounting axis and a sensor logic circuit configured to communicate with a vehicle wheel alignment system control unit, the improvement comprising:
an imaging array disposed in the vehicle wheel alignment angle sensor unit having at least two parallel rows of pixel elements, said imaging array operatively coupled to the sensor logic circuit; and
an imaging means disposed in relationship to the imaging array, said imaging means configured to direct light from a remote light source to form an image on said imaging array;
wherein said imaging array is configured to output image information representative of a location on said imaging array of said image; and
further including a processor configured to receive said information and to calculate an angular orientation of the imaging array utilizing said received information, said angular orientation representative of at least two vehicle wheel alignment angles.

18. The improved vehicle wheel alignment system of claim 17 wherein said processor is associated with said sensor logic circuit in said vehicle wheel alignment angle sensor unit.

19. The improved vehicle wheel alignment sensor unit of claim 17 wherein said processor is associated with said vehicle wheel alignment system control unit.

20. The improved vehicle wheel alignment sensor unit of claim 17 wherein said two vehicle wheel angles are selected from a set of wheel alignment angles including toe, camber, and caster adjust.
